(19) United States
(12) Patent Application Publication
(10) Pub. No.: US 2018/0002556 A1
(43) Pub. Date: Jan. 4, 2018

(54) IMAGE FORMING METHOD AND INK SET

(71) Applicant: CANON KABUSHIKI KAISHA, Tokyo (JP)

(72) Inventors: Motokazu Kobayashi, Yokohama-shi (JP); Yoshinori Kotani, Yokohama-shi (JP); Satoshi Yamabi, Yokohama-shi (JP); Kenichi Iida, Kawasaki-shi (JP); Takeshi Honma, Tokyo (JP); Shiori Yonezawa, Tokyo (JP)

(21) Appl. No.: 15/544,862

(22) PCT Filed: Jan. 19, 2016
(86) PCT No.: PCT/JP2016/000251

§ 371 Date: Jul. 19, 2017

(30) Foreign Application Priority Data
Jan. 23, 2015 (JP) 2015-011625
Jan. 15, 2016 (JP) 2016-006445

(51) Int. Cl. C09D 11/54; B41M 5/00; C09D 11/037; C09D 11/322

(52) U.S. Cl. CPC C09D 11/54; C09D 11/322; B41M 5/0023; C09D 11/037

(57) ABSTRACT

An image forming method includes a step of forming a white image by bringing a solution (A) containing a dissolved metal compound and a solution (B) containing a reactive ion reactive with a metal element of the metal compound into contact with each other on a recording medium to produce a white compound.

### TECHNICAL FIELD

The present invention relates to image forming methods and ink sets.

### BACKGROUND ART

The commercial printing market has recently focused on methods for forming images on non-white recording media, such as transparent and semitransparent films and colored paper. Forming images on such non-white recording media involves forming white images.

One of the methods for forming white images is a method using white inks in which white pigment particles are dispersed. Typical white pigment particles are often inorganic particles, such as titanium oxide particles. Because such inorganic particles have a large specific gravity, when white inks in which these inorganic particles are dispersed are left to stand in ink tanks, the inorganic particles may settle over time. When particles settle in ink tanks, not only may uneven images be formed but also nozzles may be clogged. Therefore, there has been a need to regularly circulate or stir inks in ink tanks.

To solve these problems, an image forming method using an ink set including a liquid (ink composition) containing colloidal fine particles of titanium oxide and a liquid (reaction liquid) containing a flocculant for causing aggregation of colloidal fine particles of titanium oxide has been provided (PTL 1). The image forming method described in PTL 1 involves reacting the ink composition and the reaction liquid on a recording medium to form white images.

### CITATION LIST

### Patent Literature

PTL 1: Japanese Patent Laid-Open No. 2002-103783

### SUMMARY OF INVENTION

### Technical Problem

In the ink set used in the image forming method described in PTL 1, titanium oxide is present as colloidal fine particles. Such fine particles are less likely to settle in ink tanks than titanium oxide particles having a large particle size and dispersed in white inks known in the art.

In liquids containing colloidal fine particles, however, colloidal fine particles may aggregate and settle when the liquids are stored for a long time or when impurities are present in ink tanks.

The present invention provides an image forming method for forming white images.

In this method, particles are unlikely to settle in ink tanks.

### Solution to Problem

An image forming method according to the present invention includes a step of forming a white image by bringing a solution (A) containing a dissolved metal compound and a solution (B) containing an ion reactive with a metal element of the metal compound into contact with each other on a recording medium to produce a white compound.

Further features of the present invention ill become apparent from the following description of exemplary embodiments.

### DESCRIPTION OF EMBODIMENTS

The present invention will be described in detail by way of exemplary embodiments of the present invention.

An image forming method according to an embodiment includes a step of forming a white image by bringing a solution (A) containing a dissolved metal compound and a solution (B) containing an ion reactive with a metal element of the metal compound into contact with each other on a recording medium (hereinafter referred to simply as a “medium”) to produce a white compound. The solution (A) contains and the solution (B). By the image forming method according to this embodiment, a white image can be formed. In the image forming method according to this embodiment, an ink set including the solution (A) and the solution (B) is used.

The “solution” as used herein does not refer to a liquid, such as a colloidal dispersion, in which fine particles are uniformly dispersed in a dispersion medium. In other words, in a “solution containing a dissolved compound X ” as used herein, the compound X is electrolytically dissociated, ionized, and uniformly dispersed in a solvent, or oligomers of the compound X are uniformly dispersed in a solvent. Therefore, the Tyndall effect due to the compound X does not occur in the solution according to this embodiment containing the dissolved compound X.

Ink Set

Detailed description of components in an ink set according to an embodiment is given below.

Solution (A)

The solution (A) according to this embodiment is a solution containing a dissolved metal compound X (hereinafter referred to simply as a “compound X”). In the image forming method according to this embodiment, the solution (A) is brought into contact with a solution (B) described below on a medium to cause a metal element to react with the solution (B). As a result, a white compound Z (hereinafter referred to as a “compound Z”) is obtained as a precipitate.

The metal element contained in the solution (A) may be any metal element as long as the compound Z that is precipitated as a result of reaction between the metal element and the solution (B) is white. Examples of the metal element include magnesium (Mg), sodium (Na), aluminum (Al), silicon (Si), zinc (Zn), zirconium (Zr), calcium (Ca), barium (Ba), titanium (Ti), and niobium (Nb). These metal elements tend to form white compounds as a result of being bonded to various anions. The produced compound Z may be a compound having a low solubility in the solvent used.

The solution (A) according to this embodiment is a solution obtained by dissolving the compound X in a solvent. Thus, the compound X. used to prepare the solution (A) may be a compound having a high solubility in the solvent used. An aqueous medium may be used as a solvent for easy handling. When an aqueous medium is used as a solvent, the compound X may be a salt containing a metal element and may be an ionic crystal or a polar molecule from the viewpoint of solubility in an aqueous medium. The metal element dissolved in the solution (A) may be present as a metal ion, a complex, or a complex ion.

Specific examples of the compound X include, but are not limited to, magnesium chloride, magnesium sulfate, acetylacetone magnesium, magnesium disodium ethylenediaminetetraacetate, magnesium borate, magnesium citrate, magnesium. formate, magnesium hexafluorosilicate, magnesium hydrogen phosphate, magnesium hydroxide, magnesium nitrate, magnesium lactate, magnesium oxalate, magnesium phosphate, magnesium silicate, magnesium thiocyanate, disodium ethylenediaminete-traacetate, sodium chloride, aluminum acetate, aluminum ammonium sulfate, aluminum lactate, aluminum hydroxide, aluminum nitrate, aluminum oxalate, aluminum potassium sulfate, aluminum sodium sulfate, aluminum chloride, potassium aluminate, potassium hexafluoroaluminate, calcium metasilicate, potassium silicate, sodium silicate, zinc acetate, zinc chloride, zinc disodium ethylenediaminetetraacetate, zinc sulfate, zinc borate, zinc citrate, zinc diphosphate, zinc formate, zinc lactate, zinc nitrate, zinc tartrate, acetylacetone zirconium, zirconium sulfate, zirconium chloride, calcium chloride, calcium citrate, acetylacetone calcium, calcium acetate, calcium benzoate, calcium gluconate, calcium formate, calcium hydrogen phosphate, calcium hydroxide, calcium lactate, calcium maleate, calcium nitrate, calcium oxalate, barium chloride, barium acetate, barium hydroxide, ammonium titanium oxalate, potassium. titanium oxalate, titanium bis(ammonium lactato)dihydroxide, titanium diisopropoxybis(acetylacetonate), titanium tetraacetylacetonate, titanium dioctyloxybis(octyleneglycolate), titanium diisopropoxybis(ethylacetoetate), titanium diisopropoxybis(triethanolaminate), and titanium lactate. When an organic solvent is used as a solvent of the solution (A), for example, aluminum ethoxide, aluminum isopropoxide, aluminum butoxide, ethyl silicate, titanium butoxide, and titanium isopropoxide may be used as the compound X.

The concentration of the compound X in the solution (A) may he 1 mass % or more and a saturated concentration or less. When the concentration of the compound X is 1 mass % or more, a large amount of the compound Z can be precipitated. When the concentration of the compound X is a saturated concentration or less, the compound X can be completely dissolved in the solution (A) to form a homogeneous solution.

When the compound X is unstable in the solution, the compound X may be stabilized by reaction with another compound in advance and used. When, for example, titanium (Ti) or niobium (Nb) is used as a metal element, an organic acid, such as lactic acid or citric acid, is used to form a complex or a complex ion so that the compound X becomes stable in an aqueous solution. The compound X may have a high solubility in the solvent of the solution (A). When a compound with low solubility is used, the solubility may be controlled by, for example, adding another solvent for enhancing e dissolution of the compound in the solvent or adjusting the pH.

Solution (B)

The solution (B) according to this embodiment is a solution containing a reactive ion that causes precipitation of a white compound. Z when reacted with a metal element contained in the compound X dissolved in the solution. (A).

The solution (B) may be a solution in which a compound Y, which causes precipitation of the white compound Z when reacted with the metal element dissolved in the solution (A), is dissolved in the solvent. The compound Y is any compound that provides the reactive ion when dissolved in the solvent and causes precipitation of the white compound Z when reacted with the metal element dissolved in the solution (A). The compound Y can be freely selected in consideration of combination with the metal element.

When the metal element dissolved in the solution (A) is present as a metal ion, the compound Z may be a salt in which the metal ion contained in the solution (A) is bonded to an anion being a reactive ion contained in the solution (B).

For example, when the metal element is calcium, such as when calcium chloride is used as the compound X, phosphate compounds, such as sodium phosphate, can be used as the compound Y. This is because a calcium salt of phosphoric acid (compound Z), such as calcium phosphate, which is produced by reaction of a phosphate ion being a reactive ion with calcium, is white and has a low solubility in aqueous media and other solvents. In addition, ammonium phosphate, phosphoric acid, or the like can be used as a phosphate compound.

When the metal element is calcium, sulfate compounds, such as sodium sulfate, can also be used as the compound Y. This is because a calcium salt of sulfuric acid (compound Z), such as calcium sulfate, which is produced by reaction of a sulfate ion being a reactive ion with calcium, is white and has a low solubility in aqueous media and other solvents. When the metal element is barium, sulfate compounds, such as sodium sulfate, can be used as the compound Y.

When an organic acid complex of titanium, such as titanium bis(ammonium lactato)dihydroxide, is used as the compound X, a basic aqueous solution can be used as the solution (B). That is, for example, potassium hydroxide, sodium hydroxide, or ammonia can be used as the compound Y. This is because the compound. Z, such as titanium oxide or titanium hydroxide, which is produced by hydrolysis of an organic acid complex of titanium under basic conditions, is white and has a low solubility in aqueous media. The same applies to the cases of using organic acid complexes of niobium and silicon.

The concentration of the compound Yin the solution (B) may be 1 mass % or more and a saturated concentration or less. When the concentration of the compound Y is mass % or more, a large amount of the compound Z can be precipitated. When the concentration of the compound Y is a saturated concentration or less, the compound Y can be completely dissolved in the solution (B) to form a homogeneous solution.

Solvent

The solution (A) according to this embodiment is a solution in which the compound X is dissolved in a solvent. The solution (B) according to this embodiment is a solution in which the compound Y is dissolved in a solvent. The solvent according to this embodiment is not limited to particular solvents, but an aqueous medium may be used as a solvent, for easy handling. The aqueous medium used in this embodiment may be water alone or a solvent mixture of water and a water-soluble organic solvent. Deionized water (ion exchange water) may be used as water. The water-soluble organic solvent may have an effect of enhancing the dissolution of the compound X and the compound Y and an effect of inhibiting drying of the aqueous medium.

Specific examples of the water-soluble organic solvent according to this embodiment include, but are not limited to, C1 to C4 alkyl alcohols, such as methyl alcohol, ethyl alcohol, n-propyl alcohol, isopropyl alcohol, n-butyl alcohol, sec-butyl alcohol, and teat-butyl alcohol; amides, such as dimethylformamide and dimethylacetamide; ketones and ketone alcohols, such as acetone and diacetone alcohol; ethers, such as tetrahydrofuran and dioxane; polyalkylene glycols, such as polyethylene glycol and polypropylene glycol; alkylene glycols containing C2 to C6 alkylene groups, such as ethylene glycol, propylene glycol, butylene glycol, triethylene glycol, 1,2,6-hexanetriol, thiodiglycol, hexylene glycol, and diethylene glycol; lower alkyl ether acetates, such as polyethylene glycol monomethyl ether acetate; glycerol; lower alkyl ethers of polyhydric alcohols, such as ethylene glycol monomethyl ether, ethylene glycol monoethyl ether, diethylene glycol methyl ether, diethylene glycol ethyl ether, triethylene glycol monomethyl ether, and triethylene glycol monoethyl ether; polyhydric alcohols, such as trimethylolpropane and trimethylolethane; N-methyl-2-pyrrolidone; 2-pyrrolidone; and 1,3-dimethyl-2-imidazolidinone. These water-soluble organic solvents may be used alone or as a mixture of two or more.

The proportion of the aqueous medium in the solution (solution (A) or solution (B)) according to this embodiment may be, but not necessarily, 1 mass % or more and 95 mass % or less with respect to the total mass of the solution. When the proportion of the aqueous medium is 1 mass % or more with respect to the total mass of the solution, the solution can have a low viscosity. When the proportion of the aqueous medium is 95 mass % or less with respect to the total mass of the solution, an image having a high degree of whiteness can be formed. When the solution contains a water-soluble organic solvent, the content of the water-soluble organic solvent may be, but not necessarily, 3 mass % or more and 50 mass % or less with respect to the total mass of the solution.

Other Components

The solution (solution (A) or solution (B)) according to this embodiment can further contain a polymer compound. The polymer compound contained in the solution can improve the scratch resistance of white images obtained by the image forming method according to this embodiment. The polymer compound may be a water-soluble polymer. The polymer compound may be a nonionic water-soluble polymer compound that does not react with other components in the ink set.

Specific examples of the polymer compound according to this embodiment include, but are not limited to, resins, including polyacrylamide; polyvinyl pyrrolidone; water-soluble celluloses, such as carboxymethyl cellulose, hydroxymethyl cellulose, and hydroxypropyl cellulose; and polyvinyl methyl ether, polyvinyl acetal, and polyvinyl alcohol.

The above polymer compounds may be water-soluble polymers or may be in the of a dispersion, such as a latex or an emulsion.

The proportion of the polymer compound in the solution according to this embodiment may be 0.01 mass % or more and 20 mass % or less with respect to the total mass of the solution.

The solution (solution (A) or solution (B)) according to this embodiment may optionally contain, in addition to the above components, for example, a polymer compound other than the above-mentioned polymer compound, a surfactant, a defoamer, and a preservative, unless the scope and advantages of the present invention are impaired.

The solution (solution (A) or solution (B)) according to this embodiment may contain organic fine particles to improve the visibility of the compound Z on a medium. The diameter of the fine particles according to this embodiment is preferably 10 nm or more and 1000 nm or less, more preferably 20 nm or more and 600 nm or less. The fine particles according to this embodiment may be shaped and made of materials so as not to settle in an aqueous solution. That is, porous or hollow fine particles having a lower apparent specific gravity may be used. Although the fine particles according to this embodiment, which are organic fine particles, tend to have a lower specific gravity than inorganic fine particles, the apparent specific gravity can be further reduced by using such porous or hollow fine particles. As a result, the fine particles added are less likely to settle in ink tanks.

Specific examples of the organic fine particles according to this embodiment include, but are not limited to, fine particles formed of polyolefins, such as polyethylene and polypropylene; vinyl polymers, such as polystyrene, polyacrylates, and polyvinyl acetate; condensation polymers, such as polyesters, phenol resins, polyurethanes, and polyimides; and naturally-occurring polymers. These may be used alone or as a mixture of two or more.

As described above, the ink set according to this embodiment includes the solution (A) containing the dissolved compound X and the solution (B) containing the dissolved compound Y. The formation of a white image using the ink set according to this embodiment, as described below in detail, involves bringing the solution (A) and the solution (B) into contact with each other on a medium. As a result, the compound X and the compound Y react with each other so that the compound Z, a white compound, is precipitated and forms a white image.

Image Forming Method

Next, an image forming method according to an embodiment 1 be described in detail.

The image forming method according to this embodiment includes a step of for a white image by bringing a solution (A) containing a dissolved metal compound solution (B) containing a reactive ion reactive with a metal element of the metal compound into contact with each other on a recording medium to produce a white compound.

The recording medium is a medium on which a white image is formed by the image forming method according to this embodiment. Examples of the recording medium that can be used include, but are not limited to, paper, films formed of polymer materials, such as polyvinyl chloride and PET, plastic, metal, wood, and fabric.

In the image forming method according to this embodiment, the solution (A) and the solution (B) are applied to a medium. The solution (A) and the solution (B) are thus brought into contact with each other on the medium and, as a result, the compound Z is precipitated to form a white image on the medium,

Examples of methods for applying the solution (solution (A) or solution(B)) to a medium include, but not are limited to, a method for ejecting droplets of the solution to allow the droplets of the solution to land on a medium, a method for applying the solution to a medium using a roller or the like, and a method for bringing a capillary having the solution at its tip into contact with a medium. Of these methods, a method for ejecting droplets of the solution to allow the droplets of the solution to land on a medium is preferred because the resolution of formed images can be improved.

An inkjet method is one of methods for ejecting droplets of a solution to allow the droplets of the solution to land on a medium. Examples of the inkjet method include a method for discharging droplets of a solution (ink) by applying mechanical energy to the solution (ink) and a method for discharging droplets of a solution (ink) by applying thermal energy to the solution (ink) and thus foaming the ink.

The solution (A) and the solution (B) are mixed on a medium by bringing the solution (A) and the solution (B) into contact with each other on the medium. As a result, the solution (B) reacts with a metal element in the solution (A) and the white compound. Z is precipitated. Alternatively, ejected droplets of the solutions (A) and (B) may be brought into contact, with each other before landing on a medium and then allowed to land on the medium.

The order in which the solutions (A) and (B) are applied to a medium is not limited to a particular order. In other words, after the solution (A) is applied to a medium, droplets of the solution (B) may be applied to the medium so that at least some of droplets of the solution (B) overlap droplets of the solution (A) applied to the medium. Alternatively, after the solution (B) is applied to a medium, droplets of the solution (A) may be applied to the medium so that at least some of droplets of the solution (A) overlap droplets of the solution (B) applied to the medium. Alternatively, droplets of the solution (A) and droplets of the solution (B) may be simultaneously applied to a specific region on a medium so that these droplets overlap each other.

Of these methods, the method in which one of the solution (A) and the solution (B) is applied to a recording medium and then the other solution is applied to overlap the one solution may be employed. The white compound Z can be stably precipitated accordingly. When this method is employed in an inkjet method and droplets of the solution are applied to a recording medium by an inkjet method, the density of nozzles from which the solution is discharged can be increased. The resolution of a formed white image can be improved accordingly.

In the image forming method according to this embodiment, inks known in the art containing other color materials may be used together with the ink set according to this embodiment. Specifically, inks containing color materials of colors, such as yellow, magenta, cyan, and black, can be used together with the ink set according to this embodiment to form images of full color including white. Alternatively, images of colors other than white may be formed, by using coloring inks containing other color materials, on a white image formed by using the ink set according to this embodiment.

Color Tone of White Compound

In the image forming method according to this embodiment, the solution (A) and the solution (B) are mixed on a recording medium and, as a result, the white compound Z is precipitated to form a white image. The color tone of the compound Z on the recording medium may satisfy the following relationship from the viewpoint of the visibility of the white image.

That is, the color tone of the compound Z on the recording medium may be as follows: in the L*a*b* color space (CIE 1976), the L* value is 50 or more and 100 or less, the a* value is −5 or more and +5 or less, and the b* value is −10 or more and +5 or less.

In the L*a*b* color space, the L* value represents lightness where an L* value of 0 yields black and an L* value of 100 indicates diffuse white. That is, a higher L* value indicates a color closer to white. Thus, the L* value is preferably 50 or more and 100 or less, more preferably 55 or more and 100 or less, and still more preferably 60 or more and 100 or less. An image having a color tone closer to pure white can be formed by deposition of the compound Z having a color tone with an L* value in such ranges.

In the L*a*b* color space, the a* value and the 11* value represent chromaticity components, namely, hue and saturation. The negative a* direction is the green direction and the positive a* direction is the red direction. The negative b* direction is the blue direction and the positive b* direction is the yellow direction. An a* value smaller than −5 indicates a color closer to green, whereas an a* value larger than +5 indicates a color closer to red. A b* value smaller than −10 indicates a color closer to blue, whereas a b* value of +5 or more indicates a color closer to yellow. Therefore, the a* value may be −5 or more and +5 or less, and the b* value may be −10 or more and +5 or less.

The L* value, the a* value, and the b* value of a formed white image can be determined with a spectrophotometer.

### EXAMPLES

Although the present invention will be described below in more detail by way of Examples, the present invention is not limited to the following Examples.

### Example 1

A 50% aqueous solution of dihydroxybis(ammonium lactato)titanium (available from Alfa Aesar) was used as a solution (A). A 3 mol/L aqueous solution of sodium hydroxide was used as a solution (B). An A4-size OHF' film (available from A-ONE G.K.) was used as a recording medium.

One droplet of the solution (A) was placed on the film with a dropper, so that 0.03 g of the solution (A) was applied to the film. Immediately after that, one droplet of the solution (B) was placed, with a dropper, at the same position as the solution (A), so that 0.03 g of the solution (B) was applied to the film. The droplets on the film were then dried at room temperature to provide a white image.

### Example 2

A 1 mol/L aqueous solution of calcium nitrate (available from Kishida Chemical Co., Ltd.) was used as a solution (A). A 0.5 mol/L aqueous solution of sodium phosphate (available from Kishida Chemical Co., Ltd.) was used as a solution (B). As in Example 1, a white image was formed on the same recording medium as that in Example 1.

### Example 3

A 1 mol/L aqueous solution of calcium chloride (available from Kishida Chemical Co., Ltd.) was used as a solution (A). A 1 mol/L aqueous solution of sodium phosphate (available from Kishida Chemical Co., Ltd.) was used as a solution (B). As in Example 1, a white image was formed on the same recording medium as that in Example 1.

### Example 4

A 1 mol/L aqueous solution of calcium nitrate (available from Kishida Chemical Co., Ltd.) was used as a solution (A). A 1 mol/L aqueous solution of diammonium hydrogenphosphate (available from Kishida Chemical Co., Ltd.) was used as a solution (B). As in Example 1, a white image was formed on the same recording medium as that in Example 1.

### Example 5

A 1 mol/L aqueous solution of epic—in nitrate (available from Kishida Chemical Co., Ltd.) was used as a solution (A). A 1 mol/L aqueous solution of sodium sulfate (available from Kishida Chemical Co., Ltd.) was used as a solution (B). As in Example 1, a white image was formed on the same recording medium as that in Example 1.

### Example 6

A 1 mol/L aqueous solution of barium chloride (available from Kishida Chemical Co., Ltd.) was used as a solution (A). A 1 mol/L aqueous solution of sodium sulfate (available from Kishida Chemical Co., Ltd.) was used as a solution (B). As in Example 1, a white image was formed on the same recording medium as that in Example 1.

### Example 7

A 1 mol/L aqueous solution of barium acetate (available from Kishida Chemical Co., Ltd.) was used as a solution (A). A 1 mol/L aqueous solution of sodium sulfate (available from Kishida Chemical Co., Ltd.) was used as a solution (B). As in Example 1, a white image was formed on the same recording medium as that in Example 1.

### COMPARATIVE EXAMPLE 1

One droplet (0.03 g) of a latex ink (LX-100, available from Mimaki Engineering Co., Ltd.) was placed on the same recording medium as that in Example 1 with a dropper. The droplet on the recording medium was then dried at room temperature to form a white image.

Evaluation of Images

The lightness (L* value) and the chromaticity (a* value and b* value) were measured by using a spectrophotometer (CM-2600d, available from Konica Minolta, Inc). The measurement was carried out by a SCI mode including specularly reflected light. Images were rated. A if the L* value was 50 or more and 100 or less, the a* value was −5 or more and +5 or less, and the b* value was −10 or more and +5 or less and rated B if otherwise. The results are shown in Table 1.

Evaluation of Sedimentation Property

The solutions (A) and the solutions (B) used in Examples 1 to 7 and the white ink solution used in Comparative Example I were evaluated for their sedimentation property.

Each of the solutions (30 mL) was placed in a 50 mt, glass sample vial, tightly sealed, and allowed to stand at room temperature. After standing for 2 weeks (14 days), each sample vial was slowly tilted and determined for whether a sediment was present at the bottom of the sample vial. The sedimentation property was evaluated as follows: the solution with no sediment was rated A; and the solution with a sediment was rated B. The results are shown in Table 1.

TABLE 1

| | Image Evaluaton | | | | Sedimentation |
|---|---|---|---|---|---|
| | L* | a* | b* | Rating | Property |
| Example 1 | 61.48 | −2.38 | −6.73 | A | A |
| Example 2 | 67.10 | 0.51 | 1.39 | A | A |
| Example 3 | 87.16 | −0.21 | 1.33 | A | A |
| Example 4 | 91.58 | 0.00 | 1.30 | A | A |
| Example 5 | 81.55 | 0.11 | 1.61 | A | A |
| Example 6 | 84.24 | −1.32 | −2.13 | A | A |
| Example 7 | 76.21 | −1.25 | −2.75 | A | A |
| Comparative | 62.87 | −1.35 | −1.97 | A | B |
| Example 1 | | | | | |

As shown in Table 1, images formed in Examples 1 to 7 were found to have a color tone sufficient to express white as in Comparative Example 1. In the sedimentation property evaluation, a white sediment was observed in the latex ink of Comparative Example 1. This sediment may have resulted from precipitation of titanium oxide, which was a white pigment contained in the latex ink. In contrast, no sediment was observed in the solutions of the ink sets according to Examples 1 to 7. From the above results, the white images formed by the image forming method employing the present invention were found to have the same degree of whiteness as the white image formed by an image forming method using a white ink that has been used in the art. According to the image forming method employing the present invention, an image forming method for forming white images is provided in which particles in ink tanks are unlikely to sediment compared with an image forming method known in the art.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-011625, filed Jan. 23, 2015 and No. 2016-006445, filed Jan. 15, 2016, which are hereby incorporated by reference herein in their entirety.

1. An image forming method, comprising:
a step of forming a white image by bringing a solution (A) containing a dissolved metal compound and a solution (B) containing a reactive ion reactive with a metal element of the metal compound into contact with each other on a recording medium to produce a white compound.

2. The image forming method according to claim 1, wherein the metal element is at least one element selected from the group consisting of magnesium, aluminum, silicon, zinc, zirconium, calcium, barium, titanium, and niobium.

3. The image forming method according to claim 1, wherein the white compound is a compound different from the metal compound.

4. The image forming method according to claim 1, wherein the white compound is a compound containing the metal element.

5. The image forming method according to claim 1, wherein the metal compound is a salt containing the metal element.

6. The image forming method according to claim 1, wherein the metal element is present as a metal ion, and the white compound is a salt in which the metal element contained in the solution (A) is bonded to the reactive ion contained in the solution (B).

7. The image forming method according to claim 1, wherein the metal element is calcium or barium.

8. The image forming method according to claim 1, wherein the reactive ion is a phosphate ion or a sulfate ion.

9. The image forming method according to claim 1, wherein the metal element forms a complex in the solution (A).

10. The image forming method according to claim 9, wherein the metal element is titanium or niobium.

11. The image forming method according to claim 1, wherein the step is a step of ejecting droplets of the solution (A) and the solution (B) by an ink jet method and thus applying the solution (A) and the solution (B) to the recording medium.

12. The image forming method according to claim 1, wherein the step is a step of applying the droplets of the solution (B) onto the droplets of the solution (A) on the recording medium in such a manner that the droplets of the solution (B) overlap the droplets of the solution (A).

13. The image forming method according to claim 11, wherein the step is a step of applying the droplets of the solution (A) onto the droplets of the solution (B) on the recording medium in such a manner that the droplets of the solution (A) overlap the droplets of the solution (B).

14. The image forming method according to claims 1, wherein, in an L*a*b* color space, the white compound has a color tone with an L* value of 50 or more and 100 or less, an a* value of −5 or more and +5 or less, and a b* value of −10 or more and +5 or less.

15. An ink set, comprising:
a solution (A) containing a dissolved metal compound; and
a solution (B) containing a reactive ion that causes precipitation of a white compound when reacted with a metal element of the metal compound.

16. The ink set according to claim 15, wherein the metal element is at least one element selected from the group consisting of magnesium, aluminum, silicon, zinc, zirconium, calcium, barium, titanium, and niobium.

17. The image forming method according to claim 7, wherein the reactive ion is a phosphate ion or a sulfate ion.

18. The image forming method according to claim 17, wherein the step is a step of ejecting droplets of the solution (A) and the solution (B) by an ink jet method and thus applying the solution (A) and the solution (B) to the recording medium.

19. The ink set according to claim 15, wherein the metal element is calcium or barium.

20. The image forming method according to claim 19, wherein the reactive ion is a phosphate ion or a sulfate ion.
